(19) United States
(12) Patent Application Publication
(10) Pub. No.: US 2020/0184568 A1
(43) Pub. Date: Jun. 11, 2020

(54) SYSTEM AND METHODS FOR PROCESSING PLANS HAVING DATA AND CONDITIONS APPLICABLE TO A POPULATION

(71) Applicant: Zach BORNHEIMER, Margate, FL (US)

(72) Inventor: Zach BORNHEIMER, Margate, FL (US)

(21) Appl. No.: 16/701,960

(22) Filed: Dec. 3, 2019

Related U.S. Application Data
(60) Provisional application No. 62/774,641, filed on Dec. 3, 2018.

(51) Int. Cl. G06Q 40/08

(52) U.S. Cl. CPC G06Q 40/08

(57) ABSTRACT

A platform and associated methods manage and recommend a number of plans to a user. Processes to manage the plans access supplied user data to create a person object or representation. Parsed user data can be used. Plans are excluded using various criteria. Parameters are processed as defined in a configuration system along with checks to determine if a particular plan fits, does not fit, or is inconclusive. The determination considers, for example, conditions and medications for the user when excluding plans. Results of potential plans are provided to the user.

### FIELD OF THE INVENTION

The present invention relates to a system having a front end accessor and a core database along with associated methods for managing a plurality of plans having data and conditions applicable to a population.

### DESCRIPTION OF THE RELATED ART

Most consumers purchase various plans, such as insurance, based on price and little other information. Consumers also have to consider a large variety of plans with numerous options and criteria. Agents are pressured to sell the plans with the most return while some companies promote cheap plans with marketing gimmicks that have no relation to the level of service or care provided. This process may not serve the consumer well or provide adequate coverage. Further, providing such plans can take time by filling out paperwork, visiting insurance agents, and the like.

### SUMMARY OF THE INVENTION

A method for determining at least one plan for a user from a plurality of plans is disclosed. The method includes generating a digital personal representation of user data. The user data includes parameters that apply to an object for the personal representation. The method also includes checking to determine if a plan meets any exclusion criterion according to the parameters of the personal representation. The method also includes processing each parameter defined along with additional checks to determine whether the parameter fits according to the plan. The method also includes determining if the plan is excluded based upon the processing. The method also includes returning the plan as recommended or excluded based upon the determination.

A computing platform for determining at least one plan for a user from a plurality of plans is disclosed. The computing platform is configured to generate a digital personal representation of user data. The user data includes parameters that apply to an object for the personal representation. The computing platform also is configured to check to determine if a plan meets any exclusion criterion according to the parameters of the personal representation. The computing platform also is configured to process each parameter defined along with additional checks to determine whether the parameter fits according to the plan. The computing platform also is configured to determine if the plan is excluded based upon the processing. The computing platform also is configured to return the plan as recommended or excluded based upon the determination.

A method for processing a plurality of plans for a user is disclosed. The method includes creating a person object. The method also includes processing user data for the person object. The method also includes creating a person representation using the user data and generated missing data based on the user data. The method also includes assembling plan data structures for the plurality of plans. The method also includes determining whether the person representation meet any exclusionary criterion according to the plan data structures. The method also includes, for non-exclusionary plans, determining whether the person representation meets a criterion for each non-exclusionary plan. The method also includes returning a sorted list of determined plans.

A computing platform for processing a plurality of plans for a user is disclosed. The computing platform is configured to create a person object. The computing platform also is configured to process user data for the person object. The computing platform also is configured to create a person representation using the user data and generated missing data based on the user data. The computing platform also is configured to assemble plan data structures for the plurality of plans. The computing platform also is configured to determine whether the person representation meet any exclusionary criterion according to the plan data structures. The computing platform also is configured to, for non-exclusionary plans, determine whether the person representation meets a criterion for each non-exclusionary plan. The computing platform also is configured to return a sorted list of determined plans.

A method for sorting a plurality of plans is disclosed. The method includes processing a plurality of medications to keep only applicable medications to the personal representation. The method also includes processing a plurality of conditions to keep only applicable conditions to the personal representation. The method also includes checking that each plan of the plurality of plans has a rank that is equal or worse than the worst rank of the medications. The method also includes checking that the each plan of the plurality of plans has a rank that is equal or worse than the worst rank of the conditions. The method also includes adding the plan to a list of recommended plans based on the checking steps.

A computing platform sorting a plurality of plans is disclosed. The computing platform is configured to process a plurality of medications to keep only applicable medications. The computing platform also is configured to check that each plan of the plurality of plans has a rank that is equal or worse than the worst rank of the medications. The computing platform also is configured to process all conditions to keep only applicable conditions. The computing platform also is configured to check that the each plan of the plurality of plans has a rank that is equal or worse than the worst rank of the conditions. The computing platform also is configured to add the plan to a list of recommended plans based on the checking steps.

### BRIEF DESCRIPTION OF THE DRAWINGS

Various other features and attendant advantages of the present invention will be more fully appreciated as the same becomes better understood when considered in conjunction with the accompanying drawings.

FIG. 1 illustrates a system having a plan management platform according to the disclosed embodiments.

FIG. 2A illustrates a block diagram of the plan management platform for implementing the disclosed processes according to the disclosed embodiments.

FIG. 2B illustrates a block diagram of a system to process a plurality of plans using a front end accessor and a core according to the disclosed embodiments.

FIG. 3 illustrates a flowchart for managing plans using the platform according to the disclosed embodiments.

FIG. 4 illustrates a flowchart for analyzing a plurality of plans using the platform according to the disclosed embodiments.

FIG. 5 illustrates a flowchart for determining whether a person representation meets the criterion of a plan according to the disclosed embodiments.

FIG. 6 illustrates a flowchart for processing medications in determining whether a person representation meets applicable criteria according to the disclosed embodiments.

FIG. 7 illustrates a flowchart for processing conditions in determining whether a person representation meets applicable criteria according to the disclosed embodiments.

FIG. 8 illustrates a flowchart for a front end accessor for an application of the disclosed embodiments.

FIG. 9 illustrates a flowchart for authenticating or activating access to the front end accessor according to the disclosed embodiments.

FIG. 10 illustrates a flowchart for generating a license key according to the disclosed embodiments.

FIG. 11 illustrates a table of the status and actions to be taken based on the random string associated with a license key according to the disclosed embodiments.

FIG. 12 illustrates a flowchart for collecting data for a customer according to the disclosed embodiments.

FIG. 13 illustrates a flowchart for generating the core according to the disclosed embodiments.

FIG. 14 illustrates a flowchart for performing the analysis of the compiled data using the core to select plans according to the disclosed embodiments.

FIG. 15 illustrates a flowchart for processing medication restrictions according to the disclosed embodiments.

FIG. 16 illustrates a flowchart for processing condition restrictions according to the disclosed embodiments.

FIG. 17 illustrates a flowchart for sorting and removing plans according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

The disclosed embodiments implement processes using a front end component and back end component to analyze and determine appropriate plans, such as health insurance benefit plans, for a potential customer. The disclosed processes remove plans that do meet criteria set forth by the carriers of the plans using information from the potential customer as well as information from the plans themselves. The disclosed embodiments improve this process by quickly removing ineligible or inadequate plans based on factors and conditions. Using the health plan example, factors may include medicines being taken by the customer. Conditions relate to a state or “condition” of the customer. Using a banking example, factors may include income, investments, and savings while conditions pertain to debt and property owned by the customer.

The front end and back end components use functions within the program itself to dynamically identify conditions using the medicine being used by the customer as well as aliases and additional processing called only if needed to remove plans from consideration. The back end includes a database generated specifically for the processes that is encrypted and stored until needed. These features reduce the processing normally required to provide appropriate plans to an agent.

Removal of plans provides a practical application of the disclosed embodiments. An agent is not promoting or offering plans for which the customer does not qualify. Time is not wasted filling out applications and providing sensitive information only to be turned down. Moreover, confusion between different carriers, products, and plan is reduced by invoking the disclosed processes before sorting and identification of plans begins. For example, different names for medicines and conditions are resolved using the disclosed processes so that each plan is analyzed according to the same criteria. Further, additional conditions are automatically identified so that a complete medical history may be compiled before selection processing.

The disclosed embodiments further safeguard the back end component through piracy remediation measures as well as limiting access to the data and programs executing on the back end. The disclosed processes prevent unauthorized access to the proprietary features of the components as well as access to the plans and associated information. Users may not give out user name and passwords to colleagues to gain access to the databases and information available to the disclosed embodiments.

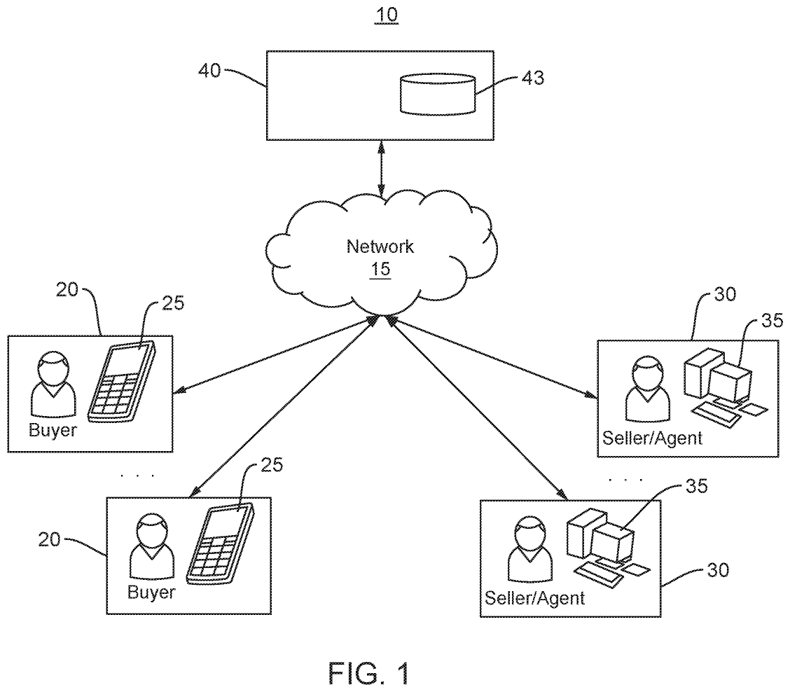

FIG. 1 depicts a system 10 having a plan management platform 40 through which potential buyers 20 and potential sellers or agents 30 may interact to provide one or more plans for purchase. Preferably, the plans relate to insurance in that different plans will apply to different consumers. The plans are not “one size fits all.” The disclosed embodiments select the best plan or plans for the consumers according to processes implemented within system 10 and by platform 40. Platform 40 may access one or more networks 15. Various users of system 10, such as potential buyers 20 and sellers/agents 30 may register with platform 40. Access to platform 40 may occur by visiting a specific website via a web browser, opening and executing an application, such as a mobile or desktop application, and the like using devices 25 and 35. Devices 25 and 35 may include any computer-based system, such as a desktop computer, laptop computer, mobile computer or tablet, phone, smart device, game device or console, personal digital assistant, and the like.

Platform 40 may include storage device 43. Data storage device 43 may be a server, database, memory location, portable memory, and the like. Data storage device 43 may store user data and other information used in executing the processes disclosed below. Data storage device 43 also may store instructions, or code, that is executed on platform 40 to manage a plurality of insurance plans. In some embodiments, the insurance plans are life care insurance plans. For illustrative purposes, the disclosed embodiments will refer to life care insurance plans below.

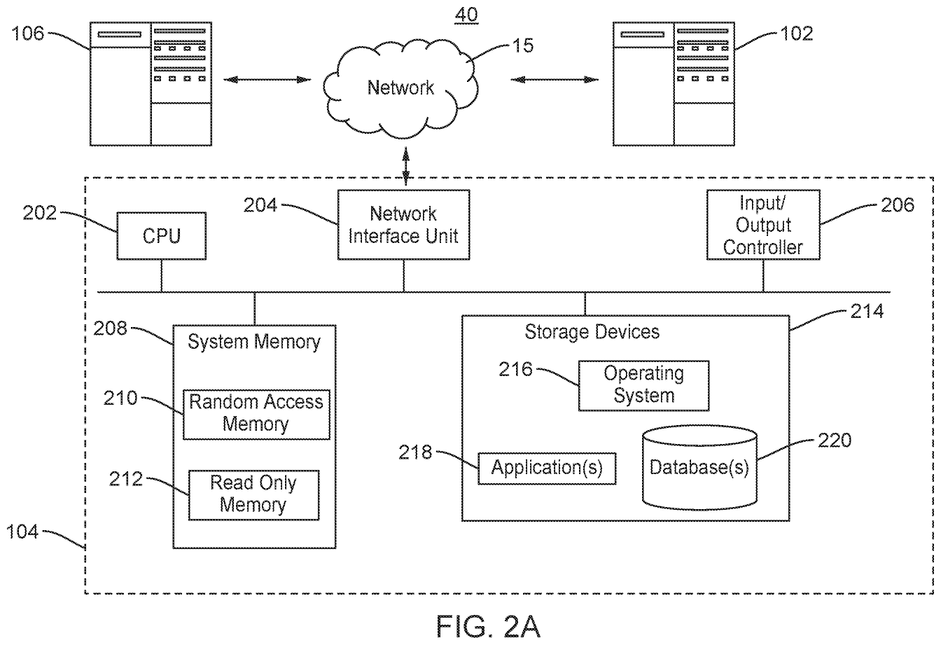

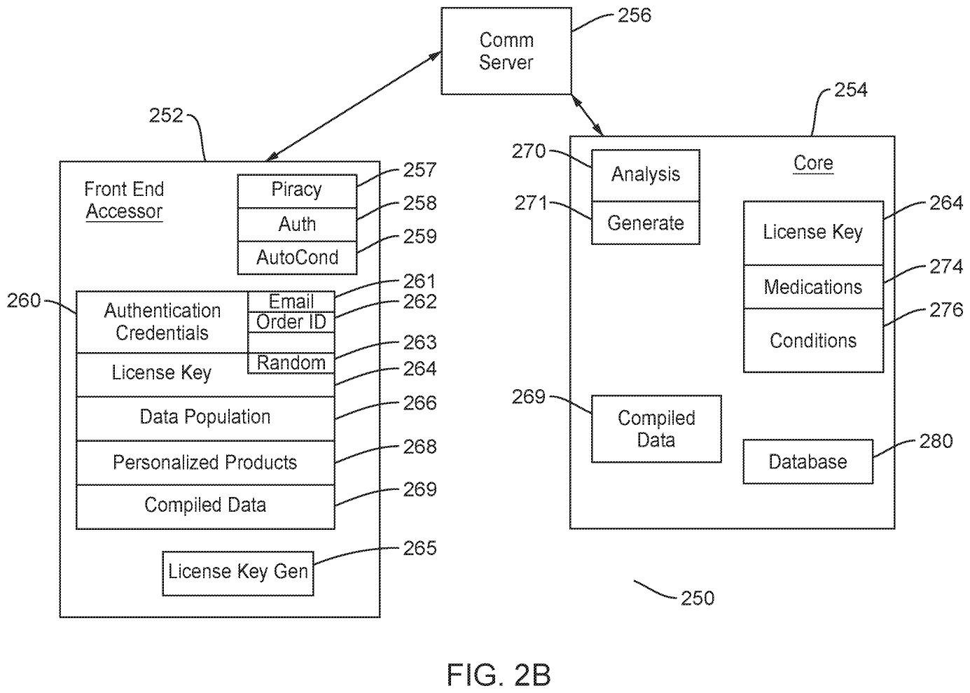

FIG. 2A depicts a block diagram of plan management platform 40 for implementing the disclosed processes according to the disclosed embodiments. Platform 40 includes a network interface unit 204, an input/output controller 206, system memory 208, and one or more data storage devices 214. Data storage device 214 may correspond to storage device 43 shown in FIG. 1. System memory 208 includes at least one read-only memory (ROM) 212 and random access memory (RAM) 210. All of these elements are in communication with central processing unit (CPU) 202 to facilitate the operation of platform 40.

Platform 40 may be a standalone computer, or, alternatively, the functions of platform 40 may be distributed across multiple computer systems and architectures. Platform 40 may be configured to perform some or all of the content processing, predictive model processing, business logic processing, and plan management processing. These functions may be distributed across multiple devices within system 10. In some embodiments, platform 40 is connected via network 15 to other servers or systems within system 10. These may be shown as servers 102 and 106.

CPU 202 includes a processor, such as one or more microprocessors. CPU 202 also may include one or more supplementary co-processors such as math co-processors for offloading workload from CPU 202. CPU 202 is in communication with network interface unit 204 and input/output controller 206, through which CPU communicates with other devices such as other servers, user terminals, devices, and the like. Network interface unit 204 or input/output controller 206 may include multiple communication channels for simultaneous communication with other processors, servers, devices, and the like. Devices in communication with each other might not continually transmit to each other. For example, such devices need only transmit to each other as necessary.

CPU 202 also is in communication with data storage device 214. Data storage device 214 may include an appropriate combination of magnetic, optical, or semiconductor memory, and may include, for example, RAM, ROM, flash drive, an optical disc, and the like. CPU 202 and data storage device 214 each may be located within a single computer or other computing device or connected to each other by a communication medium, such as a USB port, a serial port cable, a coaxial cable, an Ethernet cable, a telephone line, a radio frequency transceiver or other similar wireless or wired medium or combination of the foregoing. For example, CPU 202 may be connected to data storage device 214 via network interface unit 204.

CPU 202 may be configured to perform one or more particular processing functions. For example, platform 40 may be configured as a content processor. The content processor retrieves external data from sources on the Internet and databases 102 and 106. The content processor also accesses data sources and extracts data for predictive model processing. The content processor may extract and manipulate data from text, images, or other formats delivered through web formats and applications. Platform 40 also may be configured as a predictive model processor. The predictive model processor receives input from the content processor to determine one or more recommended results to manage plans for consumers.

Data storage device 214 may store an operating system 216 for platform 40, one or more applications 218 (such as computer program code or a computer program product) adapted to direct CPU 202 in accordance with the embodiments disclosed below. One or more databases 220 may be adapted to store information that may be utilized to store information required by platform 40. Operating system 216 or applications 218 may be stored in a compressed, an uncompiled, or an encrypted format, and may include computer program code. The instructions of the programs and applications may be read into a main memory of the processor from a computer-readable medium other than data storage device 214, such as from ROM 212 or RAM 210. While execution of sequences of instructions in the program causes CPU 202 to perform the processes disclosed herein, hardwired circuitry may be used in place of, or in combination with, software instructions for implementation of the disclosed processes.

FIG. 2B depicts a block diagram of a system 250 to process a plurality of plans using a front end accessor 252 and a core 254 according to the disclosed embodiments.

System 250 also includes communication server 256. Communication server 256 may open communication ports with front end accessor 252 and core 254 so that these components do not exchange information and data directly with each other. Communication server 256 also may perform validation or authentication actions on communications between front end accessor 252 and core 254. In some embodiments, server 256 may reside with front end accessor 252 or core 254.

FIG. 2B shows components and data structures applicable to front end accessor 252 and core 254. Front end accessor 252 executes on the “front end” or with the agent or seller at their machine. Front end accessor 252 may be an application that collects, processes, and compiles data according to the disclosed embodiments. This data may be presented to core 254 for further processing and analysis. Core 254 may be a database that requires authentication before allowing access therein. The components and data structures for front end accessor 252 and core 254 are shown for illustrative purposes. Additional components and data structures may be implemented according to the disclosed embodiments.

Front end accessor 252 may be located on device 35 for an agent or seller of plans, such as health plans, that include a large amount of data and conditions applicable to each plan. Front end accessor 252 may be implemented with a graphical user interface to display and receive input at device 35. Front end accessor 252 executes as its own program such that instructions executable on a processor configures device 35 into a special purpose machine to perform the functionality disclosed below.

Front end accessor 252 may include piracy module 257 that executes to prevent pirating of the software associated with front end accessor 252 as well as access to core 254. Authentication module 258 executes to authenticate a user of front end accessor 252 as well as validate credentials of the user to access core 254. Autocond migration module 259 may execute the automatic condition migration processes disclosed in greater detail below.

Front end accessor 252 also includes data structures that used to perform the processes disclosed below. Authentication credentials 260 may be the data needed to authenticate the usage of front end accessor 252. This data may include user email 261 and order identification 262. Front end accessor 252 also stores license key 264, which is used to access and provide data to core 254. Random number string 263 may be added to license key 264. License key 264 may execute the license key generation module 265. Data population 266 may represent the data provided to front end accessor 252 from core 254, such as medication and condition data. Personalized products and plans 268 may be product and plan data selected or created for use by front end accessor 252.

Core 254, as disclosed above, may be a database. Preferably, core 254 is a processing engine with an encrypted database component 280 that is brought online when needed by front end accessor 252. Even though it may include database 280, core 254 may include call functions that cause processes to be executed when data is being accessed. These features are disclosed in greater detail below. Core 254 may include analysis module to perform the processing and analysis of data compiled and sent by front end accessor 252 to select the best plans for a potential customer. Generate module 271 may be executed to generate the database for core 254. Core 254 also may include license key 264 for front end accessor 252 when activated. It also includes medication data structures 274, which includes all the known data of medications applicable to all the plans as well as condition data structures 276 for all applicable conditions. Data structures 274 and 276 include large amounts of data points.

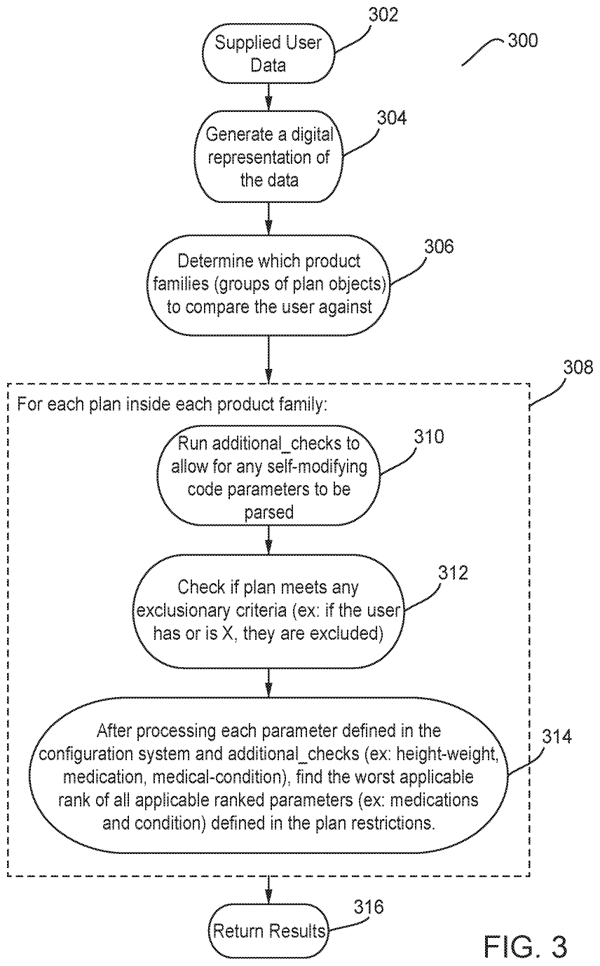

FIG. 3 depicts a flowchart 300 for managing plans using platform 40 according to the disclosed embodiments. Flowchart 300 may be implemented by platform 40 using data stored in servers 102 and 106 as well as collected over network 15. Step 302 executes by taking user data supplied via application 218 or via network 15 or other input/controllers 206. User data may include information that can be placed into objects of data such as name, age, sex, medications, height, weight, and the like. It also may include information such as hospital or doctor visits. Thus, user data should pertain the plans being managed and processed for the consumers.

Step 304 executes by generating a digital representation of the user data. The data is modeled in the software, or application 218, in a logical manner. The modeled data may be stored on platform 40 in database 220. Step 306 executes by determining which plan objects to compare against the user. In other words, certain plan objects have data that may be used to compare against data for the user. Step 306 may omit certain plans or product families from processing based around personalized products 268. Step 306 may assign different properties to the consumer, or actually the model of the person represented in the data. The properties may relate to the plan objects. This step may include analyzing a large amount of disparate data. In other words, not all user data is in a common format or in a readable form for platform 40. Some data may be digital, as stored on computer, while other data may be in a graphic form, such as a PDF of a scanned document. Platform 40 pulls the different user data need for the disclosed embodiments and uses it to determine the appropriate plan objects.

Step 308 executes by finding the right plan in a product family for each group of plan objects. Step 308 may be performed using steps 310-318 and may be repeated for each plan object staged for analysis in step 306. Step 310 executes by running or conducting additional checks to allow for any self-modifying code parameters to be parsed. Parsed user data maps all the data to the right location or to the right object. In this instance, the instructions can execute commands in the database to run the additional checks. The disclosed embodiments can execute core functions from the database assuming that functionality exists in core 254 or platform 40. Step 310 may take different parameters and modify virtual parameters by marking them in the database or modification algorithm. This step also may define exclusions, plan level, or product family.

Step 312 executes by determining if a plan meets any exclusionary criterion. For example, if the user has or is X, then that user is excluded from using the plan. “X” may pertain to a parameter found in the objects of the user data. Using another example, if X is age, then a plan only for senior citizens would be excluded from being recommended to someone being 23 years old. Some exclusions are global in nature so that many plans may be excluded early in this step such that processing requirements are reduced.

Step 314 executes by processing each parameter defined in the configuration system and additional checks being performed to determine the worst rank of applicable restrictions. For example, height, weight, medication, medical conditions may be checks used to determine whether a plan fits. The parameters within the user data are used to compare or match against the information for the user. Step 316 executes by returning the results of finding the right plan in the product family set forth by step 310.

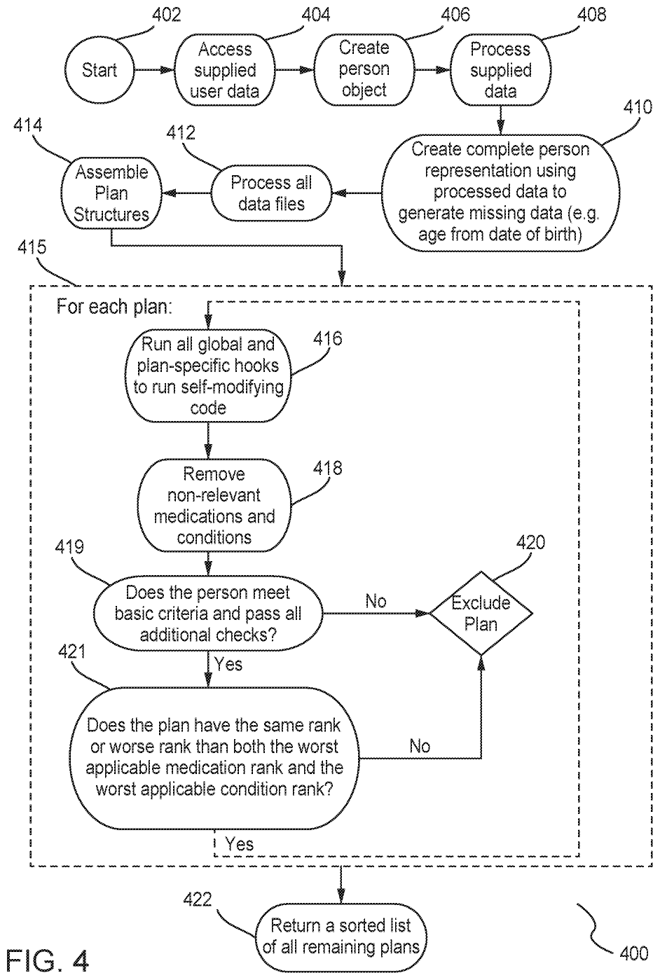

FIG. 4 depicts a flowchart 400 for analyzing a plurality of plans using platform 40 according to the disclosed embodiments. Flowchart 400 may disclose an alternative process to manage a plurality of plans, such as disclosed by flowchart 300. For example, the end result provided by step 422 may be returning a sorted list of plans, which is similar to step 316 disclosed above. Flowchart 400, however, may differ in how it accomplishes this result.

Step 402 executes by starting flowchart 400. Step 404 executes by accessing the supplied user data. Referring back to FIG. 2, user data may be stored at servers 102 and 106. As disclosed below, the user data for the customer may be provided to core 254. Alternatively, user data may be available on platform 40 in database 220. Preferably, the database is a text file which allows for encryption, integrity, and security. The user data embodied in the database may be sent to platform 40 if it is executing application 218 to implement the disclosed embodiments. The user data may be accessed via command-line switches or via an input file.

Step 406 executes by creating a person object. Preferably, the person object is created from parsed customer data obtained by the user. Thus, step 408 executes by processing the supplied data by loading the pre-existing data structures into memory supplied from the database in core 254 or processing plan files supplied from the database in core 254. Slurping may refer to reading files into memory. Step 410 executes by creating a complete person representation using the processed customer data generating missing data. For example, if a person's date of birth is provided, then the age of the person is calculated. Weight may be converted from pounds to kilograms.

Step 412 executes by processing all data files. Step 414 executes by assembling plan data structures. The disclosed embodiments read in all data files from the appropriate database and assembles plan structures while removing any data that does not apply. Steps 412 and 414 also may read in all plans being considered. Steps 412 and 414 may be omitted if the data structures are loaded directly into memory from the database in core 254.

Step 415 includes sub steps 416-421 which seek to remove plans for which the person does not qualify via the parameters within the user data. The available plans are updated using this process. Step 416 executes by running all global and plan-specific hooks or checks to run self-modifying code. In other words, step 416 runs global and plan-specific additional checks in case there is a self-modifying check, such as some item that prevents height or weight from being examined. The database may hook back to core 254 to force the core to run code that it would not normally execute.

Step 418 executes by removing non-applicable restrictions from the plan data structures. For example, step 418 may remove restrictions on cancer if, after step 408, the person doesn't have cancer or any sub-type of cancer. Step 419 determines if the person meets the basic requirements for the plan, including, but not limited to height & weight requirements and plan-specific and product-specific additional checks. If step 419 is no, then step 420 executes by excluding the plan being evaluated. If it's a yes, then step 421 executes.

Step 421 executes by determining the worst rank of all remaining components, namely the medications and conditions. If the current plan's rank is better than the worst rank, step 420 executes by excluding the plan. If the current plan's rank equal or worse than the current worst rank, the plan is left untouched and the system repeats step 415 for each remaining plan. After all plans have been evaluated, step 422 executes to return a sorted list of the best ranking plan for each requested product.

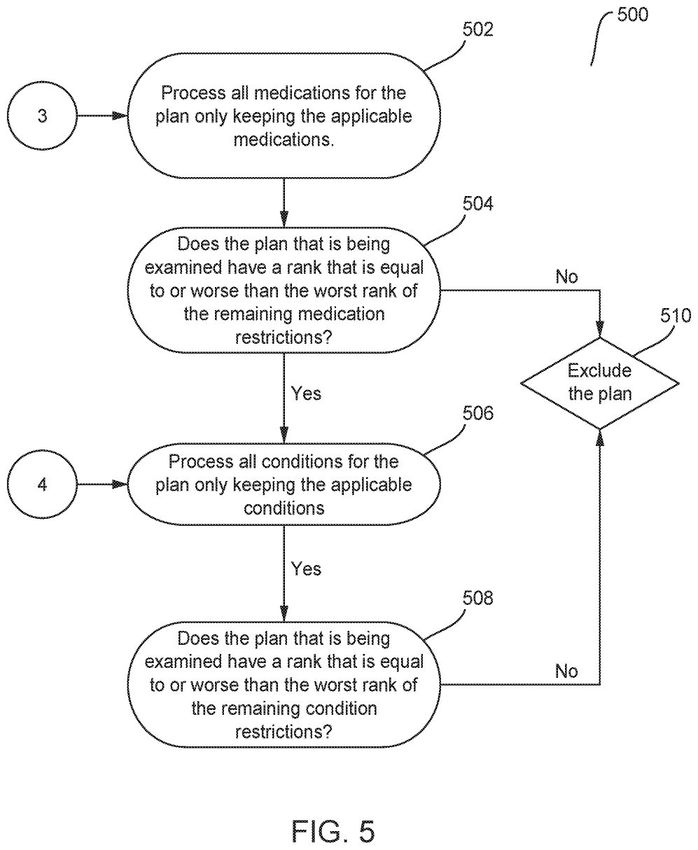

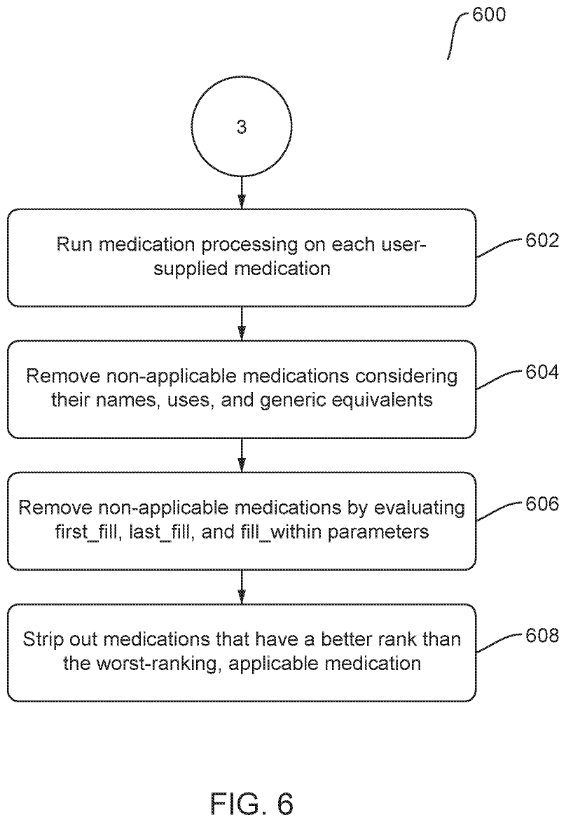

FIG. 5 depicts a flowchart 500 for determining whether a person representation meets the criterion of a plan according to the disclosed embodiments. Flowchart 500 may correspond to sub-step 418 in FIG. 4. Step 502 executes by processing all medications for the carrier only keeping the applicable medications with the worst rank. This step is disclosed in greater detail by FIG. 6. FIG. 6 depicts a flowchart 600 for processing medications in determining whether a person representation meets application criteria according to the disclosed embodiments.

Thus, step 602 executes by running medication processing on each user-supplied medication. Step 604 executes by removing non-applicable medications considering names, uses, and generic equivalents. Step 606 executes by removing non-applicable medications by evaluating first_fill, last_fill, and fill_within parameters. These parameters may correspond to the first time a prescription for the medication was filled, the last time it was filled, and a period for the medication to be provided. Fill_within may be omitted from this processing if it overlaps with the last_fill parameter, however it may serve as a synonym to the last_fill parameter. Step 608 executes by removing medications that have a better rank than the worst-ranking, applicable medication. The medications then may be provided back to flowchart 500.

For example, for each medication object in the person representation, the disclosed embodiments check to see if it abides by an defined medication restrictions. Additional processing is executed on the medication, such as date translation, generic population, and the like. This may be information obtained from provided data that need to be converted or calculated. The disclosed process may check for restrictions of the first_fill parameter for the medication. If the person representation indicates that the user takes the medication outside the window provided by the first_fill restriction, then the person representation does not meet the medication requirements for a particular plan. If the medication either is outside of the first_fill parameter window or the plan does not pose a restriction on the first_fill parameter, then the disclosed process checks if the plan restricts the fill_within or last_fill parameters and if the person representation includes data that the medication is taken within the window provided by the fill_within and last_fill parameter, such as determining whether the medication has been filled in the last two months. If the determination that medication represented in the person object matches the defined fill_within or last_fill parameters or if there are no restrictions on first_fill, fill_within, or last_fill, then the person representation meets the medication requirements for the plan. Otherwise, it does not and the restriction does not apply. This is repeated for each medication represented inside of the person representation to find a plan that meets all of the medication criteria. The goal of this process is to restrict plans to the best ranking plan that fits all of the applicable medication restrictions. For example, if a plan restricts a medication X requiring that it was filled within the last 4 months and it was actually last filled 6 months ago, the restriction defined by this plan does not apply and the process will continue to step 504.

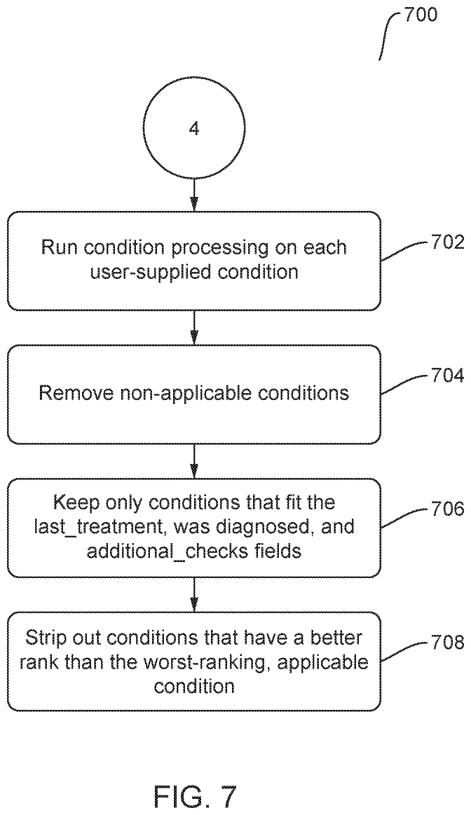

Returning back to flowchart 500, step 504 determines if all medications fit restrictions defined by the examined plan and the examined plan has a rank equal to or worse than the worst rank of the medications. If not, it excludes the plan 510 and moves to the next for that product family, or, if there are no further unexamined plans for the product family, either moves onto the next product family 308, or returns results 316. Step 506 executes by processing all conditions for the product, only keeping the application conditions with the worst rank. This step is disclosed in greater detail by FIG. 7. FIG. 7 depicts a flowchart 700 for processing conditions in determining whether a person representation meets application criteria according to the disclosed embodiments. Flowchart 700 may remove all conditions for each carrier and identify which ones are applicable to the user, or person representation.

Step 702 executes by running condition processing on each user-supplied condition. For example, the processing may convert date formats. Step 704 executes by removing non-applicable conditions from the list of conditions. The parameters may pertain to a variety of conditions but not every condition has a parameter provided by the user supplied data. If a person does not have diabetes, then conditions for diabetes need not to be checked. Step 706 executes by keeping only the conditions that fit the last_treatment, was_diagnosed, and additional_checks fields or parameters. Step 708 executes by removing conditions that have a better rank than the worst-ranking, applicable condition. The conditions may be provided back to flowchart 500.

For example, the condition may be checked to determine if it was treated within a restricted window, if a restricted window is defined. The condition also may be checked to determine if it was diagnosed within a restricted window, if a restricted window is defined. The condition may be checked to determine if it came about during a restricted age-of-onset window, if one is defined. Cross-plan conditions are resolved. In other words, one condition may have multiple applicable plan options, so the worst ranking applicable option is chosen.

Returning back to flowchart 500, step 508 executes by checking that the plan that is being examined has a rank that is equal or worse than the rank of the conditions. Step 508 may remove all plans that have a better rank than the worst rank in the conditions list. For example, if the worst rank in the conditions list is a 3, then remove all ranks better than 3. The list and rankings of the plans may be returned to flowchart 400.

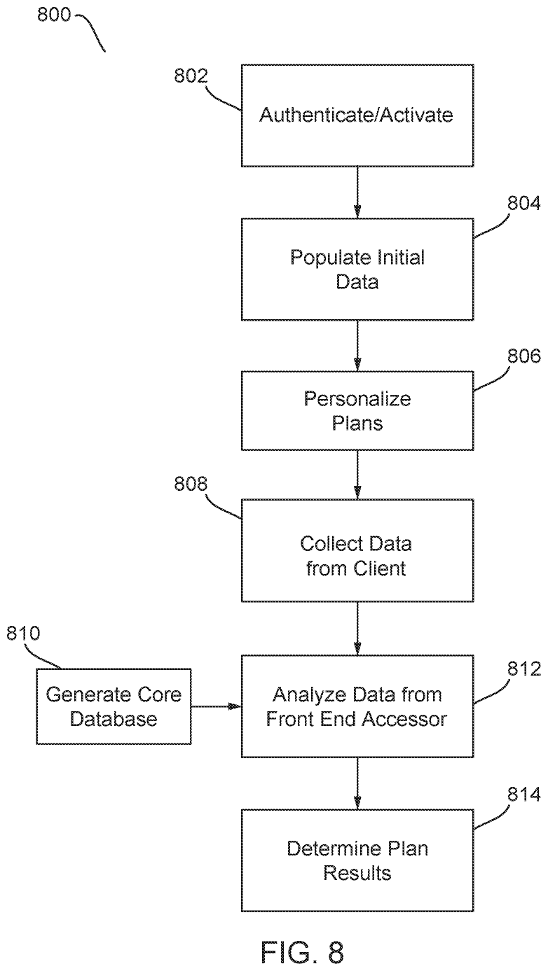

FIGS. 8-17 disclose additional embodiments of the process to use compiled data to determine the best plans to present to a customer, wherein the plans relate to a population having specific data, such as medicine, and conditions. FIGS. 8-17 refer to FIGS. 1, 2A, and 2B for illustrative purposes.

FIG. 8 depicts a flowchart 800 for processing a plurality of plans having data and conditions for a population according to the disclosed embodiments. Flowchart 800 may include the steps used to activate and validate the application for front end accessor 252 as well as obtaining data from core 254. Flowchart 800 also includes the steps to analyze data to provide recommended plans to an agent or seller for a specific customer.

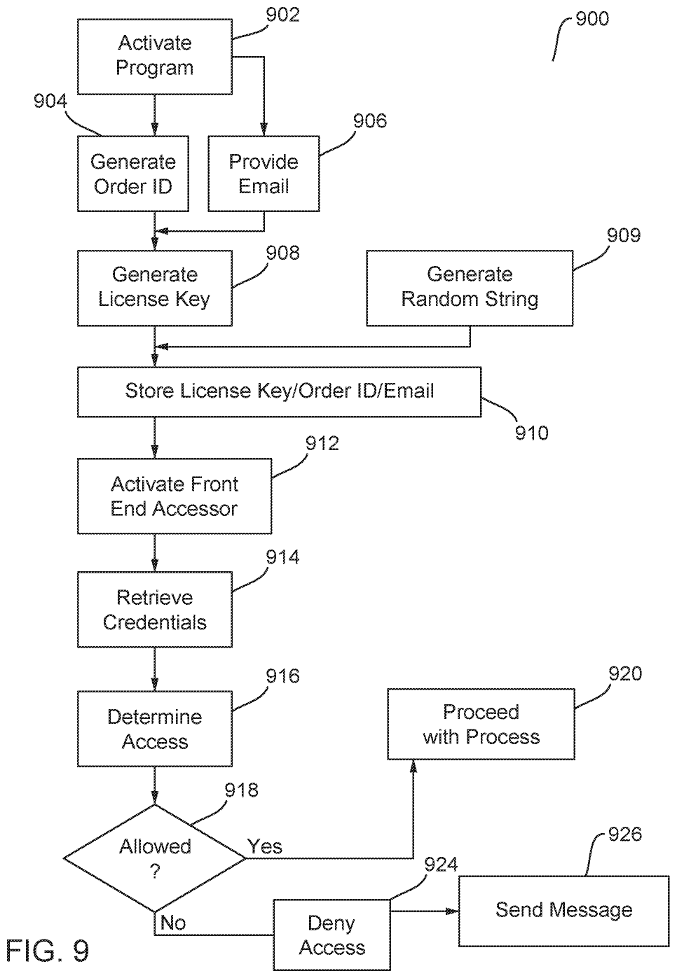

Step 802 executes by authenticating or activating the use of front end accessor 252 to propose plans to a customer. Mitigation of piracy of the associated software and data of the disclosed embodiments also is performed in this step. Step 802 also may generate license key 264 for front end accessor 252. Step 802 is disclosed in greater detail below in FIG. 9.

FIG. 9 depicts a flowchart 900 for authenticating or activating access to front end accessor 252 according to the disclosed embodiments. The steps disclosed by flowchart 900 may be used to mitigate the threat of piracy of the disclosed software components and associated data. The target audience of the disclosed embodiments are not necessarily computer savvy. Agents may share software programs and access to databases on a regular basis by intentionally or unintentionally sharing credentials with other users. For example, an agent may provide his/her user name and password to a new agent to “get started” on providing plans to customers without the need for formal training or establishing separate credentials. Further, a business may only have access to a certain number of plans and does not want to pay to increase this number. The disclosed embodiments seek to mitigate these situations and prevent unauthorized or accidental access to licensed programs as well as sensitive data stored at core 254. The disclosed processes allow for activations of programs, such as front end accessor 252, without the user maintaining the secrecy of his/her credentials being relevant.

Step 902 executes by activating the program for front end accessor 252. The user may purchase a license or request someone to be added to a current license. The user may pay an associated license fee. Step 904 executes by generating an order identification 262. Order identification 262 may be a number or other characters generated by front end accessor 252 on its payment of license fee. Step 906 also executes at some point during steps 902 and 904 by the user providing his/her email address 261. These steps may be executed by opening the disclosed embodiments at a webpage to register for access to front end accessor 252.

Step 908 executes by generating license key 264. License key 264 is generated programmatically during the activation procedure and is stored in the user's software settings, as shown in FIG. 2B being stored with front end accessor 252. License key 264 is sent to front end accessor 252 during its application program interface (API) calls. It may use a 25 character sequence comprising of 5 check digits that allow for integrity checking. Front end accessor 252 checks to ensure that the license is valid using the check digits. This process may hinder piracy amongst agents and brokers using the disclosed embodiments.

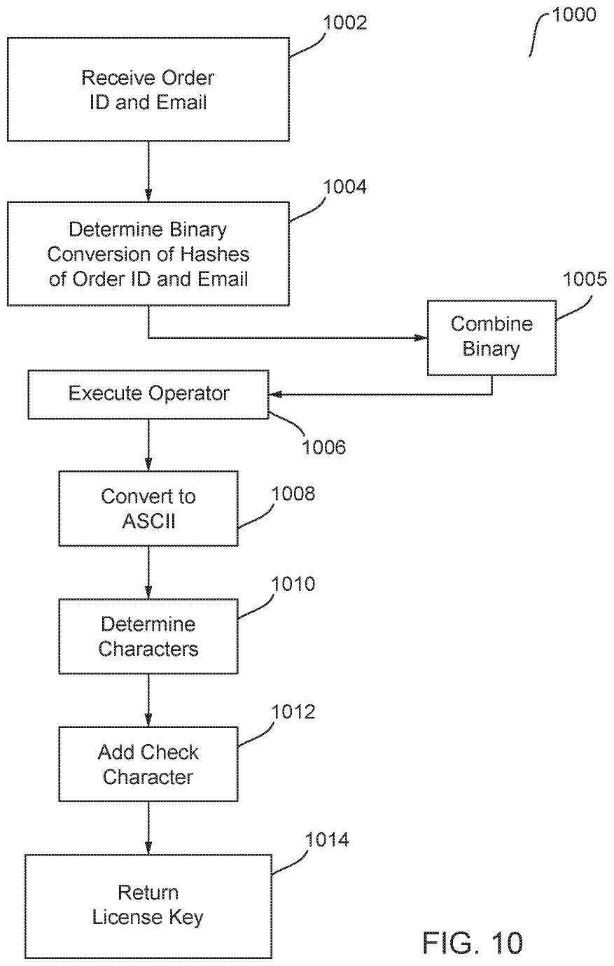

FIG. 10 depicts flowchart 1000 for generating a license key 264 according to the disclosed embodiments. Flowchart 1000 may correspond to step 908 disclosed above. Step 1002 executes by receiving order identification 262 and email 261 as provided by the user. Step 1004 determines the binary conversion of the hashes of order identification 262 and email 261. Preferably, the hashes are sha512 hashes. Step 1005 executes by combining the binary of the two lists via concatenation.

Step 1006 executes by executing an operator on the current character and the next character. In some embodiments, an xor operator is run on the current character and the next character after evaluating the “or” and “and” of both binary characters, pushing the resultant character onto a list. Step 1008 executes by converting the new characters to American Standard Code for Information Interchange (ASCII) format. The disclosed embodiments may use a script executing at front end accessor 252 to convert the characters.

Step 1010 executes by determining a number for the converted characters and getting those characters according to the disclosed embodiments. For example, twenty (20) characters may be obtained starting with a predefined choice. Step 1012 executes by adding a check character at the end of every four (4) characters by summing the previous four (4) characters. The resulting five (5) character blocks results in license key 264 with the character blocks separated by a “-”. Step 1014 executes by returning license key 264. License key 264 is stored at front end accessor 252.

Returning to flowchart 900, step 909 executes by generating a random string 263 to be included with license key 264. Random string 263 allows for multiple registrations of the same order id and email combination. Random string 263 may be a secret key that acts as a tracking agent for each device that registers into front end accessor 252. In other words, multiple devices 35 may use order id 904, email 906, and license key 264 as an agent moves around or uses different devices, such as a desktop, laptop, tablet, or smartphone. Random string 263 is checked during specific procedures and during the execution of regular queries. If random string 263 appears in the random string database table, then the disclosed embodiments know that the device has been activated before. If it does not then the disclosed embodiments know that is has not. When opening a fresh installation of the offline software, it generates a new random string. For online activation, it generates a random string if one does not exist in the stored data.

When dealing with multi-activation licenses, an intermediate procedure may be implemented that integrate random strings until the maximum activations have been reached. The intermediate procedure is a quasi-quantum mechanical algorithm that invokes being able to determine which random strings are intended to be active. There is an unknown trait to multi-license activations. Is the license's random string associated to a particular activation? If so, how can the disclosed embodiments tell the difference between a re-register due to a new device or due to piracy?

Each random string is assigned an active status, such as 0 for inactive, 1 for active, and 2 for unknown. If someone has an active random string and then activates on a new computer, then all random strings marked active become unknown, except the random string that was just created on the new computer, which is marked active, or 1. If the number of active random strings is the same as the maximum activations on the license, then all the unknowns are known to be inactive. Otherwise, the disclosed embodiments need to wait for the user to activate another one of their unknown random strings, which will then be moved to active.

Step 910 executes by storing license key 264, order identification 262, and email address 261 at front end accessor 252. These credentials may be stored in the settings of the program executing on device 35. For example, license key 264 may be stored in a browser along with other information, as disclosed below. Random string 263 also may be stored, if one was generated in step 909.

Step 912 executes by activating front end accessor 252. A user may activate to use the disclosed embodiments to analyze and propose plans to a customer. Front end accessor 252, however, must determine if access is allowed from the device executing the application. Step 914 executes by retrieving the credentials stored in the settings of front end accessor 252, such as email address 261, order identification 262, license key 264, and random string 263.

Step 916 executes by determining whether front end accessor 252, by activation 912, has access to the data and other program functions of the disclosed embodiments. During a query run, the disclosed embodiments check to see if random string 263 is the most recent string for a particular order identification 262 with the intermediate procedure disclosed above in step 909 being run after each iteration. As a result of the check, access may be allowed, as disclosed below.

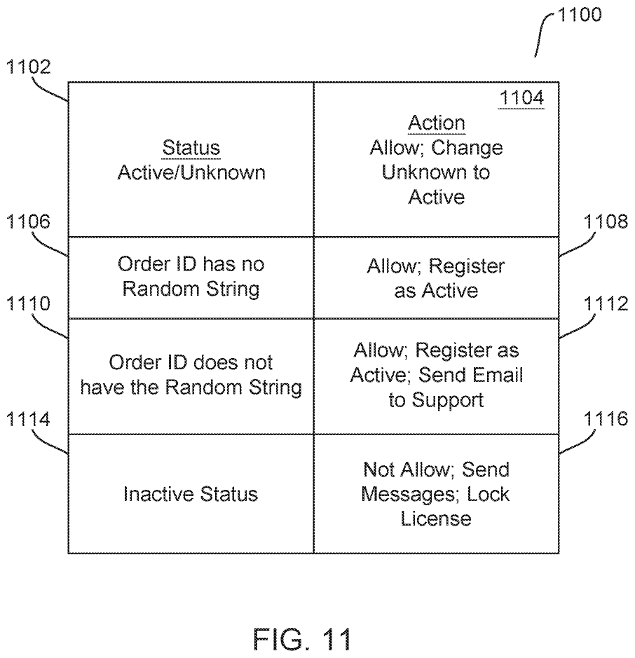

Step 918 executes by determining whether a “gate,” such as piracy module 257 or authentication module 258, will allow the query to pass through to activate front end accessor 252. Reference may be made to FIG. 11, which depicts a table 1100 of the status and actions to be taken based on random string 263 of license key 264 according to the disclosed embodiments. Based on the results of step 916, a status is determined with a resulting action being taken.

Status 1102 represents that the active status as active or unknown. Using the intermediate procedure designations disclosed above, the active status may be a 1 or a 2, which corresponds to active or unknown, respectively. Status 1102 results in action 1104. Action 1104 indicates that the gate will allow the query to pass through. Further, an unknown status may be changed to active, or changed from a 2 to a 1, for the license key and random string for the device hosting front end accessor 252. It may mark unknown status strings as inactive, or 0, if the maximum number of simultaneous activations is reached.

Status 1106 represents that order identification 262 does not have a random string associated with it. Action 1108 is taken that allows the query to pass through. The disclosed embodiments will register the random string with a status of active, or 1.

Status 1110 represents that order identification 262 was provided without a random string. Action 1112 is taken that allows the query to pass through and registering the random string with a status of active, or 1. It also may run the intermediate procedure disclosed above. The disclosed embodiments also will send an email to support staff indicating that a license corruption may have occurred along with applicable credentials, such the email, order identification, and random string. This feature will allow support to manually deal with this case of potential piracy even though the gate allows the query to pass through.

Statuses 1102, 1106, and 1110 correspond to a yes condition for step 918. As such, step 920 executes by proceeding with the disclosed processes in flowchart 800. Status 1114 corresponds to a no condition for step 918. Status 1114 represents a known random string having an inactive status, or 0. This may mean that the user has an active subscription on another device. If the user has not reached their maximum activations, the random string will not have an inactivate status, or 0. Instead the status will either be active or unknown, 1 or 2 respectively. Action 1116 is taken that does not allow the query to pass through. An appropriate message may be sent as well as displayed on device 35. The following actions may be taken with this respect.

At device 35, a message may be displayed that the maximum allowed activations for the license has been reached. The user should deactivate front end accessor 252 on another device before activating it on the current device. Further, the license may be locked temporarily and will automatically unlock after a specified period of time, such as four (4) hours. This allows use of front end accessor 252 on another currently active device without issue, if the attempted piracy is accidental and will prevent a pirated license from being activated. An email is sent to support, as disclosed in action 1112. Further, an email may be sent to the license holder that someone tried to use their license without proper credentials and that access is temporarily locked. A text message also may be sent to this effect.

Thus, referring back to flowchart 900, if step 918 is no, then step 924 executes by denying access through front end accessor 252 at device 35. Step 926 executes by sending the appropriate emails and messages as disclosed above.

Now that use of front end accessor 252 on the particular device is validated and any piracy concerns dealt with, the disclosed embodiments return to flowchart 800. Step 804 executes by populating front end accessor 252 with the initial data to execute the disclosed processes. Communication server 256 may receive license key 264 to obtain the initial data from core 254. Communication server 256 then provides the data back to front end accessor 252. This feature provides a layer of separation between front end accessor 252 and core 254. The initial data from core 254 comprises medications data structure 274 and conditions data structure 276. Access is allowed only if authenticated. The initial data may be large. For example, medications data structure 274 may include data stored for 15,000 medications.

Step 806 executes by personalizing the plans by the user. The user may go into settings to review products, also known as product families, that he/she is authorized to sell. Each product usually has several plans. The disclosed embodiments try to compare apples to apples in this process. Data on the various products and plans are brought to front end accessor 252. For example, a carrier may be cited along with applicable products having at least two plans each. The product may have a name. The plan information pertains to the type of coverage.

At least two plans are associated with each product. The two plans may be no coverage or exclude and at least a basic plan. Other plans may be available for each product as different coverages are outlined for each plan. The user also may set the personalization to a default state. Step 806 allows the user to select those products and plans that he/she is allowed or interested in selling. There is no need to provide information on products or plans that have no interest or applicability to the user.

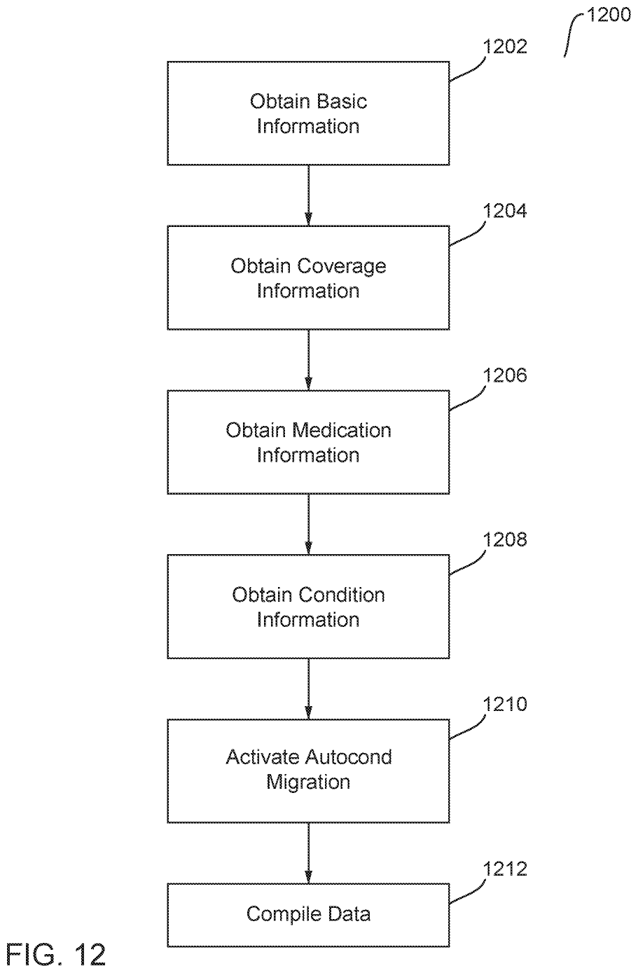

Step 808 executes by collecting data from the potential client or customer. This step is disclosed in greater detail by flowchart 1200. FIG. 12 depicts a flowchart 1200 for collecting data for a customer according to the disclosed embodiments. Step 1202 executes by obtaining basic information from the customer, such as height, weight, age, sex, and the like. Step 1204 executes by obtaining coverage information from the customer. For example, the customer may indicate how much or the type of coverage he/she is willing to purchase.

Step 1206 executes by obtaining medication information from the customer. The disclosed embodiments allow for the collection of medication information and the display of that information. The user, or agent, can also view known uses of the medication. The uses are the summation of all of the restricted uses in the plans and is not meant to be exhaustive. The known uses may come from the initial data provided in step 804 disclosed above. Other information collected for each medication should include the first fill and last fill of the prescription.

Step 1208 executes by obtaining condition information from the customer. This step allows for the collection of condition information and the display of that information. The user also may view known diagnostic criteria of the condition. These criteria are the summation of all of the diagnostic criteria given on applications and underwriting guides in the plans' definitions and is not meant to be exhaustive.

The information obtained in steps 1202-1208 may be performed in any order. The information displayed in the steps is meant to guide further questioning to the customer. For example, a customer may be on medication for so long that he/she cannot remember the initial diagnosis that led to the prescription. In some embodiments, listing of a medication will automatically add at least one condition to step 1208. First fill and last fill information may be used to populate data for the applicable condition.

Step 1210 executes by activating automatic condition, or autocond, migration. Step 1210 may activate in step 1208 when entering and addressing conditions for the customer. Autocond migration is the process in which the disclosed embodiments extrapolates conditions from data, like moving medication uses to the list of conditions and extrapolating dates from given data or adding additional conditions automatically. Autocond migration is disclosed herein as part of the front end processing but also may be performed in core 254. Autocond migration is important to get a more robust picture of the health of the customer by suggesting the agent inquire about additional, likely conditions.

Some conditions imply other conditions, especially when it comes to medical conditions. At front end accessor 252, autocond migration may prompt the user to clarify medical information with the customer. It also will determine or estimate some dates and conditions based on data provided above. For example, a customer may be prescribed oxygen. The customer indicates that it was prescribed for cancer. An autocond migration trigger will add cancer with the review indicator to the conditions list. An autocond trigger may also run to add oxygen, cancer (remission), and cancer (active) to the conditions list with the review indicator as well so that the user can discuss with their client which conditions are relevant, the dates of their diagnosis, treatment, and refining the types of their illnesses where applicable, such as narrowing cancer to cancer (lung). Potential conditions requiring oxygen, such as COPD or oxygen treatment, may be added with the relevant dates due to these prompts.

At core 254, autocond migration also may be used to apply condition restrictions of another condition to the customer, but those restrictions will not be added under the alias process, disclosed below. The criteria for autocond migration may commonly be when there is a condition that should inherit the properties of another condition, but does not meet the criteria for an alias. An alias is a categoric relationship defined as a parent and child relationship, where the child inherits properties of the parent, or a circular relationship where both properties are synonyms. If the user adds diabetic neuropathy, then core 254 will use autocond migration to add diabetes, diabetic complications, and neuropathy as autoconds of diabetic neuropathy. There may be global autoconds and local autoconds set forth in the additional requirements sections of each plan file as an additional check. If someone has diabetic neuropathy, then the disclosed embodiments should know that the customer inherits the same restrictions as diabetes but, technically, diabetes is not a more generalized version of diabetic neuropathy as they are not on the same branch of conditions, thus not a categoric relationship or synonym and, thus, not an alias. To apply the diabetes restrictions to the customer in order to exclude certain plans, the disclosed embodiments need to add the condition diabetes with the same properties as diabetic neuropathy.

Step 1212 executes by compiling the entered information and autocond migration data into compiled data structure 269. Compiled data structure 269 is then passed to core 254 for the further processing according to the disclosed embodiments. Additional features of this process may include searching. For condition names, the user can enter a partial string of characters into the name field. The disclosed embodiments, using front end accessor 252, then searches the list of conditions containing all characters and words to try and narrow down the options. If no option exists with all the search terms, then the disclosed embodiments searches for conditions containing any of the words in the search field. If the disclosed embodiments find only one match, then it places that match into the name field for the condition and removes focus to prevent additional keystrokes in the field by accident. This functions as autocomplete. If the user re-enters the name field, then an override flag is signaled that prevents autocompletion on this particular condition. The flag is reset when the condition window is closed.

Another feature may be a translation system used by front end accessor 252. The translation system is a key-value translation system where any data-focused text field translates user input into other input. The data-focused fields with the translation system enabled are medication name, medication use, and condition name. The translation system also may be used to fix typographical errors, such as CHOLESTERAL to CHOLESTEROL, deal with common abbreviations, such as HBP to HIGH BLOOD PRESSURE, and translate one condition name to another, such as HYPERTENSION to HIGH BLOOD PRESSURE. The disclosed translation system may work on individual words without having to rewrite the entire field.

At this instance, the focus of flowchart 800 moves from front end accessor 252 to core 254, or to back end processing of compiled data structure 269. Before the analysis of the compiled data can begin, core 254 must be generated or decrypted if already generated. Step 810 executes by generating core 254. This process is disclosed in greater detail by flowchart 1300.

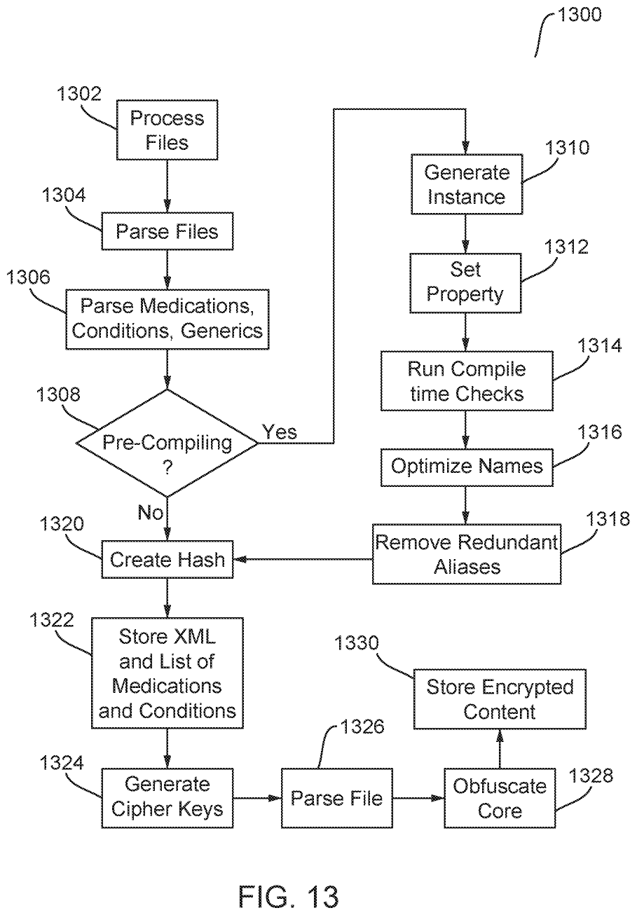

FIG. 13 depicts a flowchart 1300 for generating core 254 according to the disclosed embodiments. The disclosed process may be run by command or when a request is received from front end accessor 252. It may use code in a core base file as the root of the core and makes use of optional, but recommended, precompilation to store the data structures in a data component. If precompilation is not used, then the data component contains the concatenated XML interpolated from the plan files. The plan files may be structured in a specific manner according to the disclosed embodiments. This data may be encrypted.

Step 1302 executes by processing files that should be included in core 254. Step 1304 executes by parsing the files. The files are read and parsed into XML. This step takes data from the files to be included in the XML files or data structures. In other words, desperate files of data may be parsed to provide a set format for further processing. Step 1306 executes by parsing the medications, conditions, and generics as well as the aliases of each of these into their own lists, adding generics to the list of medications as well. The application of aliases is disclosed in greater detail below but its implementation also may be applied here.

Step 1308 executes by determining whether the core generation process is precompiling. If yes, then step 1310 executes by generating an instance for the proposed customer. For example, the instance may be someone of the age of 65 years. Step 1312 executes by setting the all plans property of the customer. Step 1314 executes by running compiletime checks. This step will allow the core to determine which plans have redundant components and keep track so the disclosed embodiments can use this information in the main analysis process disclosed below. Step 1316 executes by optimizing all restriction medication and condition names. Step 1318 executes by removing all redundant aliases in the list of aliases. Flowchart 1300 then proceeds to step 1320.

If step 1308 is no, then step 1320 executes by creating the content hash. Step 1322 executes by storing the XML and lists of medications and conditions as well as serializing it. This action binds together the database into the core file. Step 1324 executes by generating cipher keys from the serialized content hash and a secret key hardcoded into the program. Step 1326 executes by parsing the core base file to parse out a few internal signals, such as START_LITERAL and END_LITERAL.

Step 1328 executes by obfuscating the core file. This step may be implemented by a script. The script removes comments, strips multiple spaces, translates variable names to random strings from 4-21 characters based on the variable's length, removes empty lines, joins random lines, and the like. Step 1330 executes by storing the encrypted, serial content hash in the core data file. In a sense, the generated data is “frozen” until it is needed.

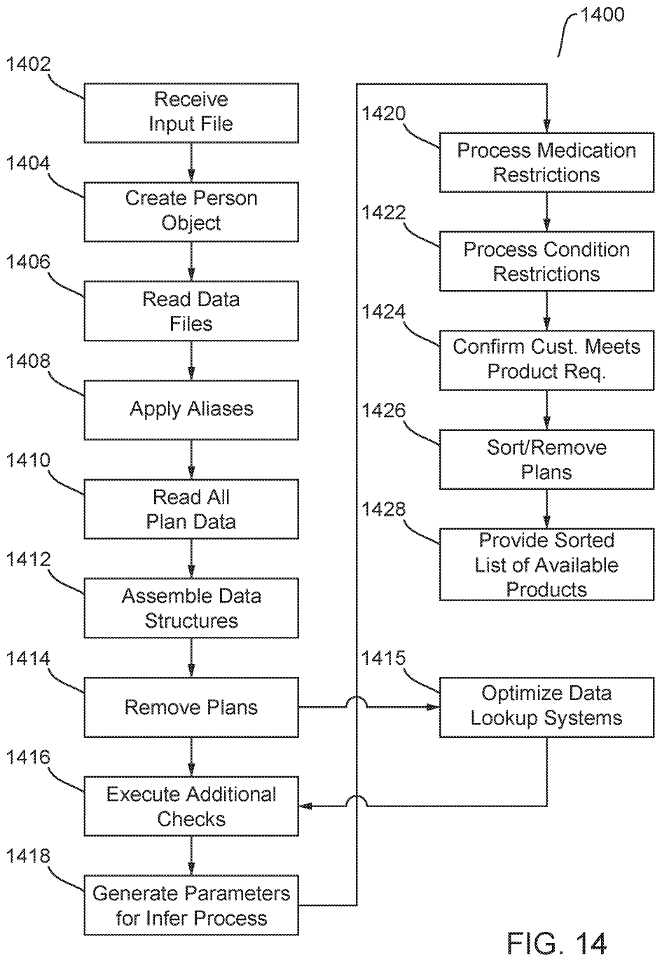

Returning to flowchart 800, step 812 executes by analyzing the compiled data from front end accessor 252 using core 254 generated in step 810. Step 812 is disclosed in greater detail by flowchart 1400. FIG. 14 depicts a flowchart 1400 for performing the analysis of the compiled data using core 254 to select plans according to the disclosed embodiments. Step 1402 executes by receiving the input file, or compiled data structure 269. The input file also may be supplied via command line switches. The input file may be configured according to the following example (provided in the data modeling language, ZEDRAM):

(open person (set-attr (set height 59) (set weight 159) (set dob 2-18-1993)))

(open medications)

(define-each (medication name/use/first_fill/last_fill)

(

Ventolin HFA/Asthama/8 years ago/1 year ago,

)

)

(close medications)
(open medical-conditions)

(define-each (medical-condition name/last_treatment/was_diagnosed)

(

Asthma/3 months ago/12 years ago,
Vocal Chord Dysfunction/3 years ago/6 years ago,

)

)

(close medical-conditions)

(close person)

If an input file is not given, then the following information may be required according to the disclosed embodiments: height, weight, date of birth, medications, and conditions with medications including name, use, first fill, and last fill, and conditions including name, last treatment, diagnose date. There may be as many entries for medications and conditions as needed.

Step 1404 executes by creating a person object from parsed user data. The person object is generated using specific data from front end accessor 252. Step 1406 executes by reading all data files. In this step, the encrypted core data file may be decrypted. The disclosed embodiments may retrieve the data model from memory. Using the frozen example, the data structure of the core file is “unfrozen” to be used according to the disclosed embodiments.

Step 1408 executes by applying aliases. The disclosed embodiments may make use of an alias system, which is a tree-like structure designed to show the relationship between objects. The alias system of the disclosed embodiments is an inheritance-based system where the properties of the parent apply to the children or two properties should apply to each other. If a condition is a more generalized version of another condition, such as heart disorder and arrhythmia, the more specific version should be aliased to the more generalized version, thereby allowing the more specific version to inherit the restrictions of the more generalized version. That way, if a carrier restricts all heart disorders, then arrhythmia reflects that restriction.

The alias system of the disclosed embodiments reflects the expansion of conditions and the intelligent processing of conditions and medications in view of this expansion. The disclosed embodiments may include thousands of aliases. The alias system does not impact the user or customer. There may be different types of aliases. One-way aliases may be normal aliases that can be visualized as several leaves and other branches (new_names) growing off of a branch (original_name). For example, gestational diabetes should inherit the properties of diabetes. If a carrier restricts diabetes, then they also restrict gestational diabetes. The inverse is not necessarily the case.

Another type of alias is a circular alias. These are less intuitive aliases that can be understood to be synonyms. Any time two aliases mean the same thing, they are circular aliases. For example, nitroglycerine and nitroglycerin should be linked to each other. Thus, if one carrier restricts nitroglycerin and another restricts nitroglycerine, the restrictions should be applied without regard to how the customer's medication name is provided.

Aliases may be read from a global file. The global file outlines alias parents and children. The results are stored in hash lookups so that anyone can file relationships.

Step 1410 executes by reading all plan data. Plans may be stored in their own files. The file may be structured as shown below in the ZEDRAM data modeling language:

(open plans (set-attr (set brand am) (set product senior-choice)))
. . . general product family requirements:
(define-each (additional-requirements requirement/type) ( . . . ))
. . . required:
(open plan (set-attr (set name EXCLUDE) (set rank 5))) (close plan)
. . . foreach plan:
(open plan (set-attr (set name NAME) (set rank RANK)))
   (define-each (height-weight inches/weight-min/weight-max) ( . . . ))
(close plan)
(open medications)
   (define-each (medication name/use/first_fill/last_fill/fill_within/plan) ( . . . ))
(close medications)
(open medical-conditions)
   (define-each (medical-condition
name/criteria/last_treatment/was_diagnosed/additional_checks/plan) ( . . . ))
(close medical-conditions)
   (close plans)

Step 1412 executes by assembling the data structures.

Step 1414 executes by removing plans and product families that the customer, according to the person object and other data, does not qualify for. Steps 1415-1426 execute this step in detail. These steps may be executed for each plan. The disclosed embodiments are interested in removing plans as quickly as possible.

Step 1415 executes by preparing and optimizing data lookup systems, or optimizing the user model/person object by removing characters and other housekeeping processes, such as converting dates. Odd characters may be entered into data and is removed in this step. The disclosed embodiments may identify non-ASCII characters in the data structures.

Step 1416 executes by executing additional checks in the event there is a self-modifying check, such as something that prevents height-weight from being examined. The process of executing additional checks is disclosed in greater detail below.

Step 1418 executes by generating the parameters for the quasi-artificial intelligence process, which infer conditions based around medications, if requested by the plan or by the supplied user data. Step 1418 also may execute to infer these conditions. The disclosed embodiments may use the alias system disclosed above and the medication and condition lists to infer which conditions that the medications imply. For example, if the disclosed embodiments determine that the medication SPIRIVA indicates a respiratory disorder, then it will tell the disclosed embodiments to infer that the customer has every respiratory disorder, to be conservative as it is impossible to know which specific respiratory disorder applies without directly being given that information.

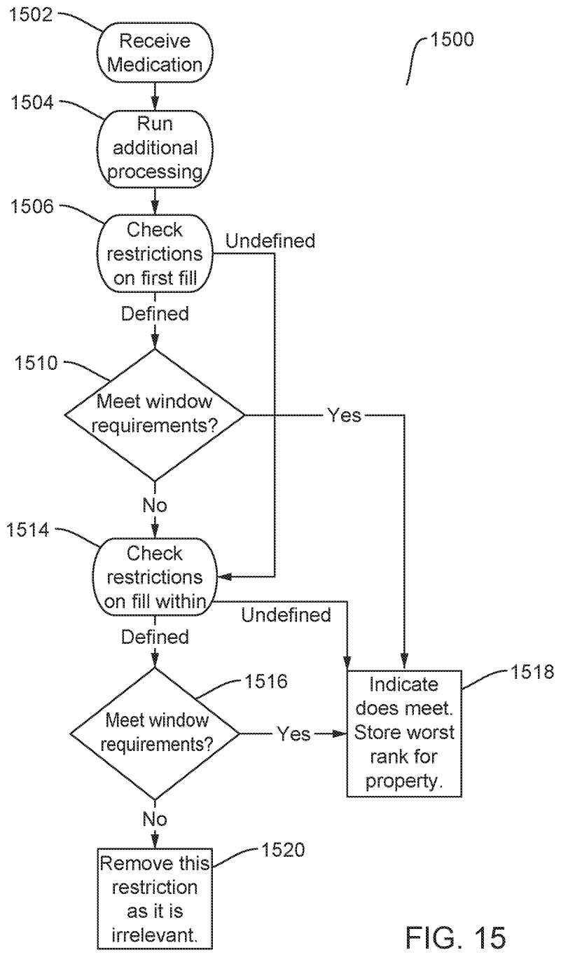

Step 1420 executes by processing medication restrictions to remove any superfluous restrictions. Step 1420 is disclosed in greater detail by flowchart 1500. FIG. 15 depicts a flowchart 1500 for processing individual medication restrictions according to the disclosed embodiments. Flowchart 1500 may be executed for each medication that the customer takes. Thus, step 1502 executes by receiving the medication name Step 1504 executes by running any additional processing on the medication. For example, acronyms or shortened names may be converted into the actual medical names for the medication.

Step 1506 executes by checking for restrictions on the first fill for the medication. The plan may have a restriction on when the first fill of the prescription may be accepted. In other words, the plan does not want to cover a condition that has been treated for several years according to the first fill of the applicable medication. Step 1510 executes by determining whether the customer takes the medication within the window provided by the first fill restriction.

If step 1510 is yes or step 1506 determines there are no restrictions for the first fill parameter, then step 1514 executes by determining a fill within restriction for the plan. If the medication is outside the first fill window or the plan does not impose a restriction on the first fill parameter, then the disclosed embodiments check to see if the customer took the medication within a fill within window. The fill within and last fill windows are synonyms. Step 1516 executes by determining whether the customer, according to the person object, takes the medication within the window provided by the fill within restriction. If no, then step 1520 executes by removing the restriction as it is unrelated to the person object. If step 1514 is not defined or 1516 is yes, then the restriction is valid and the restriction and its rank are stored in step 1518.

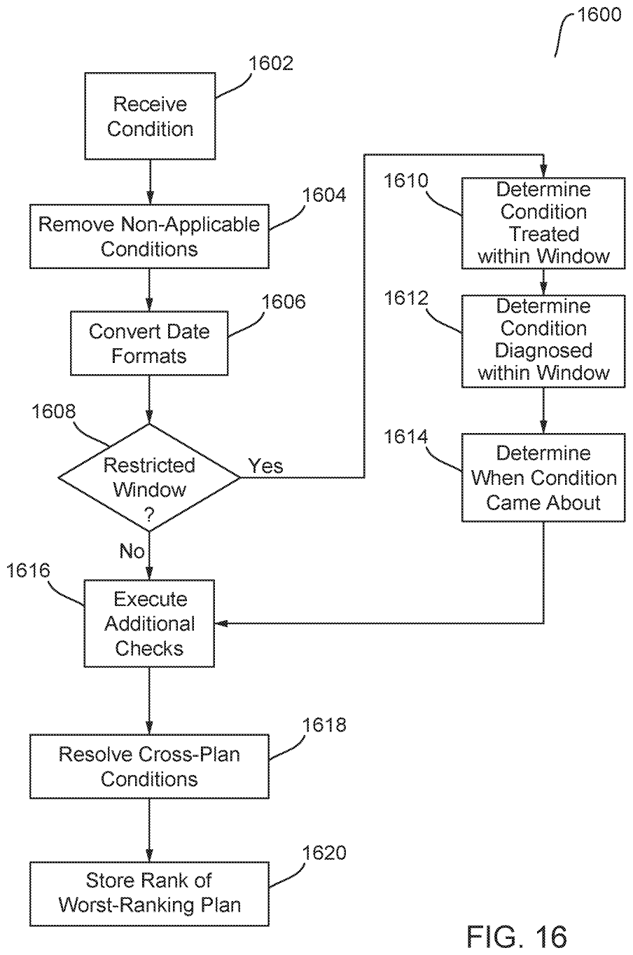

Returning back to flowchart 1400, step 1422 is executed by processing the condition restrictions for each condition within the person object for the customer. Step 1422 is disclosed in greater detail by flowchart 1600. FIG. 16 depicts a flowchart 1600 for processing condition restrictions according to the disclosed embodiments. Step 1602 executes by receiving the condition from the person object. Step 1604 executes by removing non-applicable conditions. This process may mimic the process outlined in flowchart 1500 replacing first fill with diagnosis date and fill within with last treatment. Step 1606 executes by converting date formats into the format consistent with the disclosed embodiments.

Step 1608 executes by determining whether a restricted window for the condition was defined by the plan. If yes, then step 1610 executes by determining if the condition was treated within a restricted window. Step 1612 executes by determining if the condition was diagnosed within the restricted window. Step 1614 executes by determining if the condition came about during the restricted age of onset window if a restricted window was defined at all.

If step 1608 is no, and after execution of steps 1610-14, then step 1616 executes by executing any additional checks defined by the plan or product family Additional checks may be call functions inside the code executing the disclosed processes. The additional checks may be plan or product specific. They allow for dynamic rules to expand the capabilities of the disclosed processes. If certain conditions are met, then additional actions may be taken. The intention of additional checks is to prevent redundancy. Thus, there will be times where there are additional checks that should actually be parsed into its own rule-based system instead of in the additional checks system. The additional checks may further remove plans from consideration.

Step 1618 executes by resolving cross-plan conditions. One condition may have multiple applicable plan options, so the worst ranking applicable option is chosen. Step 1620 stores the rank of the worst-ranking plan for the product family.

Returning to flowchart 1400, step 1424 executes by confirming the customer meets product requirements. Such requirements may include height and weight requirements. As noted above, each product may include at least two plans. If the customer does not meet the requirements for the product, then these plans may be removed from consideration.

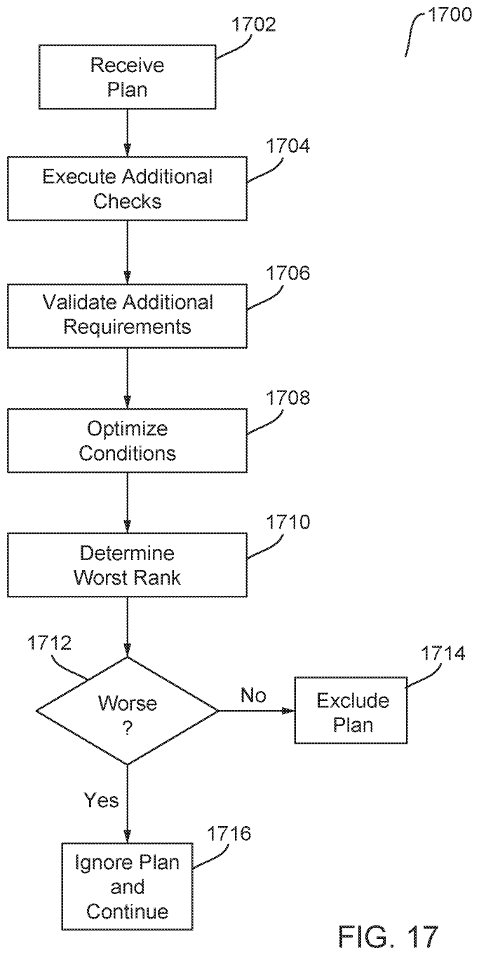

Step 1426 executes by sorting and removing plans. Step 1426 is disclosed in greater detail by flowchart 1700. FIG. 17 depicts a flowchart 1700 for sorting and removing plans according to the disclosed embodiments. Step 1704 executes by executing the additional checks process disclosed above for each plan and product family. The disclosed embodiments run additional checks to validate that the plan's additional requirements are satisfied in step 1706. If not, then exclude the plan.

Step 1708 executes by optimizing properties of the customer to remove duplicates, to merge overlapping conditions of the same name, and the like. Step 1710 executes by determining the worst rank that the customer qualifies for based around the medications and conditions, as determined above. Step 1712 executes by determining whether that worst rank is worse than the rank of the current plan. If no, then step 1714 executes by excluding the plan. If yes, then step 1716 moves on to the next plan staged for analysis until no more plans are staged for analysis.

Returning back to flowchart 1400, step 1428 executes providing the sorted list of all available products to the user, who then may present them to the customer. The plans are pared down to remove inapplicable plans or plans that will not meet the carrier's requirements or the customer's needs and only the best ranking plan for each product family is displayed. Thus, agents do not waste time marketing plans that the customer does not qualify for.

It will be apparent to those skilled in the art that various modifications to the disclosed embodiments may be made without departing from the spirit or scope of the invention. Thus, it is intended that the present invention covers the modifications and variations disclosed above provided that these changes come within the scope of the claims and their equivalents.

1. A method for determining at least one plan for a user from a plurality of plans, the method comprising:
generating a digital personal representation of user data, wherein the user data includes parameters that apply to an object for the personal representation;
checking to determine if a plan meets any exclusion criterion according to the parameters of the personal representation;
processing each parameter defined along with additional checks to determine whether the parameter fits according to the plan;
determining if the plan is excluded based upon the processing; and
returning the plan as recommended or excluded based upon the determination.

2. The method of claim 1, further comprising accessing the user data from a database.

3. The method of claim 1, further comprising running additional checks to allow for any self-modifying code to be parsed.

4. A method for processing a plurality of plans for a user, the method comprising:
creating a person object;
processing user data for the person object;
creating a person representation using the user data and generated missing data based on the user data;
assembling plan data structures for the plurality of plans;
determining whether the person representation meet any exclusionary criterion according to the plan data structures;
for non-exclusionary plans, determining whether the person representation meets a criterion for each non-exclusionary plan; and
returning a sorted list of determined plans.

5. A method for sorting a plurality of plans, the method comprising:
processing a plurality of medications to keep only applicable medications with a worst common rank;
checking that each plan of the plurality of plans has a rank that is equal or worse than the worst rank of the medications;
processing all conditions to keep only applicable conditions with a worst common rank;
checking that the each plan of the plurality of plans has a rank that is equal or worse than the worst rank of the conditions; and
adding the plan to a list of recommended plans based on the checking steps.
